(19) United States
(12) Patent Application Publication
(10) Pub. No.: US 2007/0292730 A1
(43) Pub. Date: Dec. 20, 2007

(54) Multiblock Copolymers Containing Hydrophilic Hydrophobic Segments for Proton Exchange Membrane

(76) Inventors: James E. McGrath, Blacksburg, VA (US); William Harrison, Riner, VA (US); Tom A. Wodzinski Jr, Shaker Heights, OH (US); James E. McGrath, Blacksburg, VA (US)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 10/595,654

(22) PCT Filed: Nov. 19, 2004
(86) PCT No.: PCT/US04/38691

§ 371 Date: May 23, 2007

Related U.S. Application Data
(60) Provisional application No. 60/523,332, filed on Nov. 20, 2003.

(51) Int. Cl. C08L 81/06; H01M 6/18; H01M 8/10

(52) U.S. Cl. 429/33; 521/25; 521/27

(57) ABSTRACT

Novel multiblock copolymers containing perfluorinated poly(arylene ether) as a hydrophobic segment and disulfonated poly(arylene ether sulfone) as a hydrophilic segment are provided. The multiblock copolymers are used to form proton exchange membranes that are thermally and hydrolytically stable, flexible, and that exhibit low methanol permeability and high proton conductivity. The proton exchange membranes are thus well-suited for use for use as polymer electrolytes in fuel cells.

### BACKGROUND OF THE INVENTION

1. Field of the Invention

The invention generally relates to multiblock copolymers for forming proton exchange membranes for use, for example, as polymer electrolytes in fuel cells. In particular, the invention provides multiblock copolymers containing perfluorinated poly(arylene ether) as a hydrophobic segment and disulfonated poly(arylene ether sulfone) as a hydrophilic segment.

2. Background of the Invention

The introduction of ionic groups into high-performance polymers has attracted much interest because of their potential usefulness as high-temperature-operating ion-exchange resins and polymer electrolyte membranes (PEMs) for fuel cells. Proton exchange membrane fuel cells (PEMFCs) offer potential advantages of clean and efficient energy conversion systems for automobiles, portable applications, and power generation. The principle of fuel cells is based on electrical energy being generated via electrochemical formation of water from hydrogen and oxygen. Hydrogen molecules are oxidized to protons at the anode, which migrate in the form of hydronium ions (H₃O⁺) through a proton-conducting electrolyte to the cathode.

For many years, polymer electrolyte bearing sulfonate groups have been investigated and utilized as cation exchange resins or membranes.¹⁻³ Considerable research effort has recently made on the development of PEM fuel cells or direct methanol fuel cells (DMFC), in which the PEMs serve as the barrier for fuels, and the electrolyte for transporting protons from the anode to the cathode.⁴ Currently, the sulfonated perfluorinated ionomer-based systems (Nafion®) produced by Dupont Co. (U.S. Pat. No. 4,085,071, issued Apr. 18, 1978) are used as proton exchange membranes. Nafion® membranes show relatively high proton conductivity of 10⁻¹ S cm⁻¹ at room temperature and satisfactory durability. However, they suffer from several technical limitations, such as low conductivity at low humidity or high temperatures (greater than 80° C.), and high methanol permeability. In addition, the high cost of Nafion® is also a serious disadvantage. There is thus an increasingly large amount of research activities to develop new membranes with better performance and lower cost compared to Nafion. These membranes should exhibit high durability and good performance at high operating temperatures (120-150° C.), (H₂/Air) and/or lower methanol permeability (DMFC).

Sulfonation of poly(phenylene oxide)⁵, poly(phenylene sulfide)⁶, polysulfone⁷ and poly(p-phenylene)s⁸ in order to produce new proton-exchange membranes have been studied by several research groups. In these post-sulfonated polymers, the sulfonic acid group is usually restricted to the activated sites on the aromatic ring. However, precise control over the location and degree of sulfonation can be difficult. Direct polymerization of 3,3′-disulfonate-4,4′-dihalodiphenylsulfone monomer with several bisphenolates, has been reported⁹ as a successful alternative to over come some, but only some, of the problems associated with post-sulfonation approach.

The synthesis of multiblock copolymers by reacting hydrophilic fluorine-terminated sulfonated poly(2,5-benzophenone) oligomers with hydrophobic hydroxyl-terminated biphenol poly(arylene ether sulfone) has also been reported.¹⁰ However, such multiblock copolymers suffer from the drawback that sulfonation is performed on pre-formed oligomers, thereby limiting control and/or reproducibility of material properties.

Some polymer electrolyte membranes for use in polymer electrolyte fuel cells have been known conventionally, see, e.g., U.S. Pat. No. 6,503,378 issued Jan. 7, 2003 and U.S. Pat. No. 6,670,403 issued Dec. 30, 2003, both to Fisher; U.S. Pat. No. 6,083,638 issued Jul. 4, 2000 to Taniguchi et al.; U.S. Pat. No. 5,641,586 issued Jun. 24, 1997 and U.S. Pat. No. 5,952,119 issued Sep. 14, 1999, both to Wilson; U.S. Pat. No. 5,595,834 issued Jan. 21, 1997 to Wilson et al.; U.S. Pat. No. 5,272,017 issued Dec. 21, 1993 and U.S. Pat. No. 5,316,871 issued May 31, 1994, both to Swathirajan et al., U.S. Pat. No. 6,818,341 issued Nov. 16, 2004 and U.S. Pat. No. 6,635,369 issued Oct. 21, 2003, both to Uribe et al. Some methods of making block copolymers for use in such PEMs have been provided in a conventional manner, see e.g. Fisher (U.S. Pat. No. 6,503,378), which discloses a block copolymer prepared via an addition polymerization (i.e., radical polymerization).

The prior art has thus far failed to provide multiblock copolymers capable of forming thermally and hydrolytically stable, flexible proton exchange membranes with low methanol permeability and high proton conductivity, that are economically feasible to produce.

### SUMMARY OF THE INVENTION

The present invention provides novel multiblock copolymers containing, for example, perfluorinated poly(arylene ether) as a hydrophobic segment and disulfonated poly(arylene ether sulfone) as a hydrophilic segment. The multiblock copolymers form membrane films that function as proton exchange membranes and that can be used as polymer electrolytes, for example, in fuel cells. The membrane films are thermally and hydrolytically stable, flexible, and they exhibit low methanol permeability and high proton conductivity. In addition, the multiblock copolymers and the proton exchange membranes are relatively facile and inexpensive to produce.

The invention in one preferred embodiment provides a multiblock copolymer with chemical structure (I) 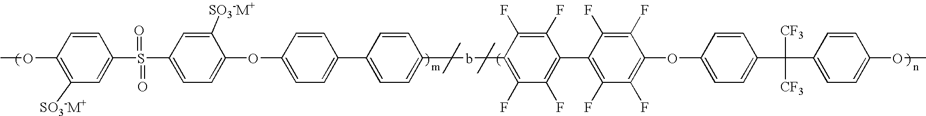
where M+ is a positively counterion selected from the group consisting of potassium, sodium and alkyl amine, m=about 2 to about 50, n=about 2 to about 30 and b represents connection of respective blocks, such as, e.g., multiblock copolymers having m+n of at least 4, multiblock copolymer having m+n from about 4 to about 80, etc.

In another preferred embodiment, the invention provides a proton exchange membrane (PEM) comprising a multiblock copolymer that comprises at least one hydrophobic segment and at least one hydrophilic segment, wherein the membrane has co-continuous morphology of hydrophobic and hydrophilic segments, has a mean humidity in a range of from about 10% to about 80%, and has proton conductivity in a range of from about 0.005 to about 0.3 S/cm; such as, e.g., PEMs having mean humidity is in a range of about 25% to 70%; PEMs having proton conductivity is in a range of about 0.05 to about 0.25 S/cm; PEMs having mean humidity is in a range of about 25% to 70% and proton conductivity is in a range of about 0.05 to about 0.25 S/cm; PEMs wherein the hydrophobic segment is perfluorinated; PEMs wherein the hydrophilic segment is disulfonated; etc.

The invention also has another preferred embodiment, in which the invention provides a method of making a multiblock copolymer comprising a fluorinated hydrophobic segment and a sulfonated hydrophilic segment, comprising the step of: reacting at least one fluorinated block (such as, e.g., a fluorinated block which itself was made by a condensation reaction; etc.) with at least one sulfonated block (such as, e.g., a sulfonated block which itself was made by a condensation reaction; etc.) in a condensation reaction to form a multiblock copolymer; such as, e.g., methods wherein the fluorinated block and the sulfonated block themselves were made by condensation reactions; methods wherein at least two fluorinated blocks and at least two sulfonated blocks are reacted in the condensation reaction; methods wherein a number of fluorinated blocks being reacted in the condensation reaction is in a range of about 2 to 30 and a number of sulfonated blocks being reacted in the condensation reaction is in a range of about 2 to 50; methods wherein a sufficient number of blocks are used in the condensation reaction to form a polymer electrolyte membrane; methods wherein the fluorinated block is a perfluorinated block; methods wherein the sulfonated block is disulfonated; methods wherein a multiblock copolymer comprising at least two perfluorinated poly(arylene ether) segments and at least two disulfonated poly(arylene ether sulfone) segments is formed; methods wherein by a step growth procedure, a proton exchange membrane is constructed; methods wherein the multiblock copolymer of above formula (I) is formed by the condensation reaction; etc.

The invention in another preferred embodiment provides an ion-exchange resin comprising a multiblock copolymer comprising at least one fluorinated hydrophobic segment and at least one sulfonated hydrophilic segment, wherein the multiblock copolymer has been formed by a condensation reaction; such as, e.g., ion-exchange resins wherein the sulfonated hydrophilic segment is disulfonated; ion-exchange resins wherein the fluorinated hydrophobic segment is a perfluorinated ether; ion-exchange resins including perfluorinated poly(arylene ether) and disulfonated poly(arylene ether sulfone) segments; etc.

Also there is another preferred embodiment of the invention providing a fuel cell comprising a polymer electrolyte membrane (PEM) according to the invention (such as, e.g., a PEM comprising a multiblock copolymer comprising: at least one fluorinated hydrophobic segment and at least one sulfonated hydrophilic segment, wherein the multiblock copolymer has been formed by a condensation reaction; etc.), an anode and a cathode.

### BRIEF DESCRIPTION OF THE DRAWINGS

FIG. 1. Scheme for synthesis of telechelic macromonomer (1).

FIG. 2. Scheme for synthesis of biphenol based poly(arylene ether sulfone) (2).

FIG. 3. Scheme for synthesis of multiblock copolymer (3).

FIG. 4. ¹⁹F NMR spectra of decafluorobiphenyl-terminated poly(arylene ether)s.

FIG. 5. Influence of relative humidity on proton conductivity; ♦ and ◯ represent two different preparations of membranes of the present invention, and ▪ represents Nafion®.

FIG. 6. Schematic representation of a generic fuel cell that comprises a proton exchange membrane of the present invention.

### DETAILED DESCRIPTION OF THE PREFERRED EMBODIMENTS OF THE INVENTION

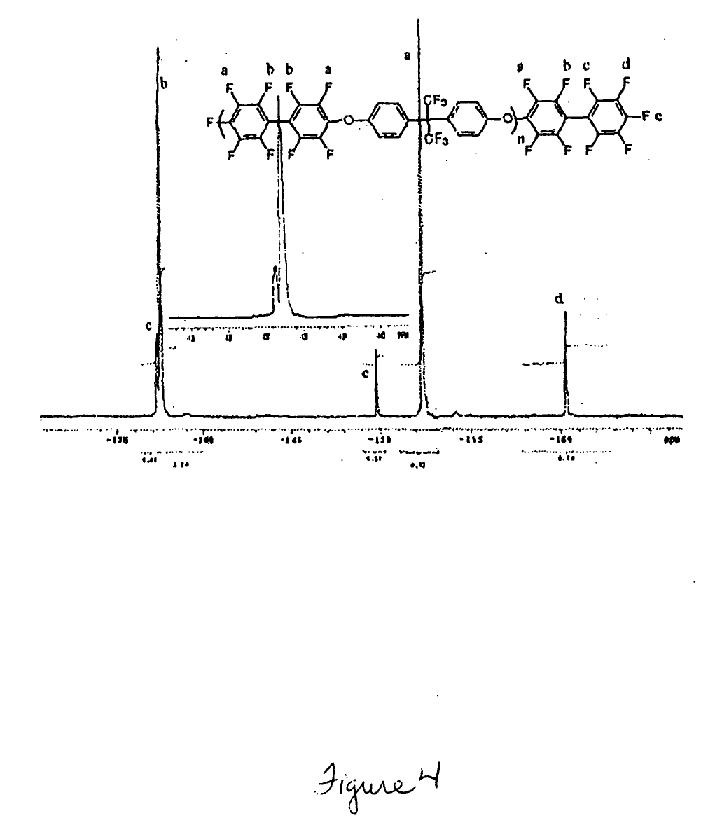

The present invention provides novel multiblock copolymers that contain both hydrophobic and hydrophilic segments. In an exemplary embodiment, the hydrophobic segment comprises perfluorinated poly(arylene ether) and the hydrophilic segment comprises disulfonated poly(arylene ether sulfone). The hydrophobic segments can vary considerably within the practice of this invention and include, for example, different segment length and various functional groups via monomer selection. The chief requirements for the hydrophobic segments are solubility, rigidity and/or flexibility, and reactive endgroups. Likewise, the hydrophilic segments can vary considerably within the practice of this invention and include, for example, different segment length and various functional groups via monomer selection. The chief requirements for the hydrophilic segments are controllable degree(s) of ionic exchange groups (i.e. sulfonic acid or carboxylic acid groups) and reactive end groups. Preferably, the molecular weight ratio of hydrophobic segments to hydrophilic segments ranges between 1000 g/mol and 20,000 g/mol, and will be specific (and adaptable) to application and operation conditions. For example, see FIG. 4.

The present invention also encompasses proton exchange membranes (membrane films) with high chemical and electrochemical stability that are formed from the multiblock copolymers of the invention. The membranes exhibit thermal and hydrolytic stability, flexibility, low methanol permeability and high proton conductivity. In particular, the membranes exhibit co-continuous morphology of hydrophobic and hydrophobic segments, which permits proton conductivity at low to medium humidity for hydrogen/air systems. By “co-continuous morphology of hydrophilic and hydrophobic segments” we mean that the hydrophobic segments microphase separate (i.e., organize) from the hydrophilic segments. The proton exchange membranes are thus well-suited for use as polymer electrolytes, for example, in proton exchange membrane fuel cells (PEMFCs).

An exemplary multiblock copolymer of the invention is depicted below.

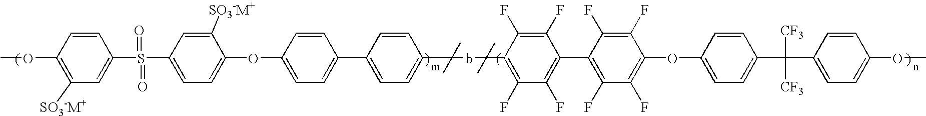

In the depiction: M+ represents a positively charged counterion such as potassium (K⁺), sodium (Na⁺), alkyl amine (⁺NR4), etc. and is preferably sodium or potassium; m represents the number of repeate units of Block 2 (the sulfonated monomer) and ranges from about 2 to about 50, and preferably from about 5 to about 15; n represents the number of repeat units of Block 1 (fluorinated monomer) and ranges from about 2 to about 30, and preferably from about 5 to about 15; and b represents the block connection. By “multiblock” we mean that the entire above figured sequence can be repeated from 0 to 50 times.

The formation of co-continous, phase separated hydrophilic and hydrophobic regions can be manipulated by those skilled in the art by varying each respective block length. Additionally, those skilled in the art can, thereby, vary several membrane properties, for example, but not limited to, proton conductivity, ion exchange capacity, water absorption, methanol permeability, and size of co-continuous phases. The co-continuous, phase separated arrangement allows for a morphology similar to the ‘proton conducting channels” credited to enhanced performance of perfluorinated membranes like Nafion.

In general, for use in the practice of the present invention, the multiblock copolymers will be in the molecular weight range of from about 10,000g/mol to about 1000,000 g/mol, and preferably from about 15,000 to about 50,000 g/mol. The choice of a preferred molecular weight range generally depends on desired hydrophilicity and ion exchange capacity, which is related to the Blocks 1 and 2 that are employed. The block length is directly proportional to the number of repeat units, which are “m” and “n” in the previous paragraph and formula.

The proton exchange membranes of the present invention exhibit co-continuous morphology of hydrophobic and hydrophobic segments, which permits proton conductivity at low to medium humidity for hydrogen/air systems. The measurement of humidity is well-known to those of skill in the art (e.g. with a humidity probe). By “low to medium humidity” we mean humidity in the range of from about 10% to about 80%, and preferably in the range of from about 25 to about 70%.

The proton exchange membranes of the present invention exhibit high proton conductivity. The measurement of proton conductivity by membranes is well-known to those of skill in the art (e.g. using an impedance analyzer). In general, the membranes of the present invention exhibit proton conductivity in the range of from about 0.005 to about 0.3 S/cm, and preferably in the range of from about 0.05 to about 0.25 S/cm.

The proton exchange membranes of the present invention also exhibit high thermal stability. The measurement of thermal stability of membranes is well-known to those of skill in the art. For example, the membranes retain their integrity and their ability to exchange protons and function as polymer electrolyte over a wide temperature range. The membranes of the invention have been evaluated and demonstrated good conductivity at temperatures from about 25° C. to about 150° C., and the examples herein disclose 120-150° C.

In addition, the proton exchange membranes of the present invention exhibit hydrolytic stability. By “hydrolytic stability” we mean resistance to degradation by water. The measurement of the hydrolytic stability of membranes is well-known to those of skill in the art. The membranes of the present invention exhibit hydrolytic stability for on the order of about at least 20,000 hours, or alternatively for on the order of about 10,000 hours.

The membranes also exhibit the flexibility that is necessary in order to be well-suited for use as polymer electrolytes. The membranes are malleable and can be creased or formed to fit a desired shape, i.e. they are not brittle.

The membranes of the present invention also exhibit low methanol permeability. The measurement of membrane methanol permeability is well-known to those of skill in the art. Additionally, those skilled in the art can manipulated the methanol permeability by changing the extent of phase separations by changing the respective block lengths. The length ratio of the hydrophilic block to the hydrophobic block and the resulting extent of phase separation will greatly influence the methanol permeability.

An additional uniqueness of the claimed system is the preparation of the multiblock via a step-growth polycondensation procedure. The connecting of the hydroxyl terminated biphenol-based poly(arylene ether sulfone) macromonomer and the activated telechelic macromonomer is known by those skilled in the art. Being able to produce these materials by such inventive procedures may provide desired stiffer, yet flexible materials with desired higher modulus, desired conductivity, etc. compared to the conventional materials. Simpler systems may be provided by the present invention compared to conventional methods of making PEMs which may, for example, require very dry solvents or other tedious details.

While the membrane films of the present invention are well-suited for use in fuel cells, those of skill in the art will recognize that other applications also exist for which the membrane films are well-suited. Examples include but are not limited to desalination membranes, gas separation, water purification, etc.

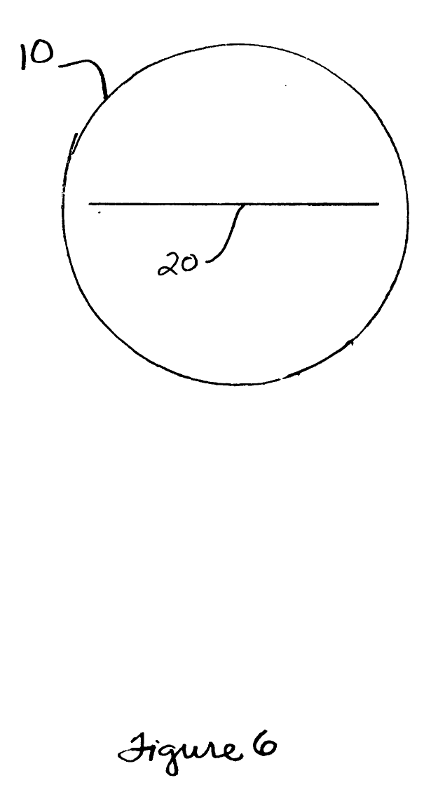

The present invention also provides a fuel cell comprising a proton exchange membrane as described herein. Those of skill in the art will recognize that many styles and formats are available for the design of fuel cells, and any such designs may incorporate the proton exchange membranes of the present invention. FIG. 6 schematically illustrates a generic fuel cell 10 in which a proton exchange membrane of the present invention 20 is used as a polymer electrolyte.

### EXAMPLES

### Experimental

Materials: All reagents were purchased from Aldrich and used as received unless otherwise noted. N-methyl-2-pyrrolidone (NMP), dimethylsulfoxide (DMSO) and N,N-dimethylacetamide (DMAc) were dried over calcium hydride, distilled under vacuum and stored under nitrogen before use. THF was dried and distilled over sodium. 4,4′Biphenol obtained from Eastman Chemical. The specialty monomer 4,4′-difluorodiphenylsulfone (DFDPS) was purchased from Aldrich and recrystallized from toluene. The sulfonated comonomer, 3,3′-disulfonated4,4′-difluorodiphenylsulfone (SDFDPS) was synthesized in-house from 4,4′-dichlorodiphenylsulfone (DFDPS) according to a method which is reported elsewhere.⁹ Decafluorobiphenyl was purchased from Aldrich Chemical Co. and dried under vacuum at 60° C. for 24 hours before use. 4,4-Hexafluoroisopropylidenediphenol (bisphenol AF or 6F-BPA), received from Ciba, was purified by sublimation and dried in vacuo.

Characterization: ¹H, ¹⁹F and ¹³C NMR analyses were conducted on a Varian Unity 400 spectrometer. Conductivity measurements were performed on the acid form of the membranes using a Solatron 1260 Impedance analyzer.

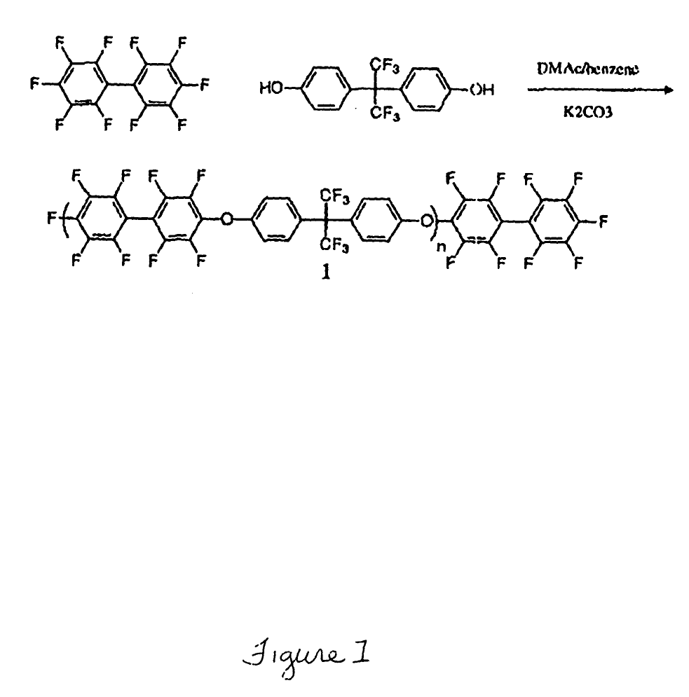

Synthesis of telechelic macromonomer (1): A typical polymerization procedure is illustrated in FIG. 1 and was as follows; decafluorobiphenyl (3.007 g, 9.0 mmol) and 6F-BPA (2.689 g, 8.0 mmol) were dissolved in DMAc (40 mL) (to make a 14% (w/v) solid concentration) and benzene (4 mL) in a reaction flask equipped with a nitrogen inlet and magnetic stirrer. The reaction mixture was stirred until completely soluble and then an excess of K₂C0₃ (3.31 g, 24 mmol) was added. The reaction bath was heated to 120° C. during 2 h and kept at this temperature for 4 h. The mixture was precipitated into 200 mL of acidic water/methanol (1:1 in volume fraction). The precipitated polymer was filtered and successively washed with deionized water. (The terms “polymer” and “oligomer” are used with the same meaning herein.) Drying of the product at 80° C. under vacuum gave essentially quantitative yield of white polymer 1. ¹H—NMR (CDCl3): § 7.10(d, 2H), 7.45(d, 2H). ¹⁹F—NMR (CDCl3): −64.0 (CF3), −137.5, −152.4 (Ar—F), −137.2, −149.8, −160.2.(Ar—F). ³C—NMR (CDCl3): 115.4, 128.8, 132.0, 157.1 (6F—BPA), 118.4, 122.1, 125.8, 129.7 (—CF3), 103.1, 134.7, 140.1, 143.3, 146.4 (fluorobiphenyl). Molecular weight: Mn=8.0K, MW=15.9K with a polydispersity of 1.97.

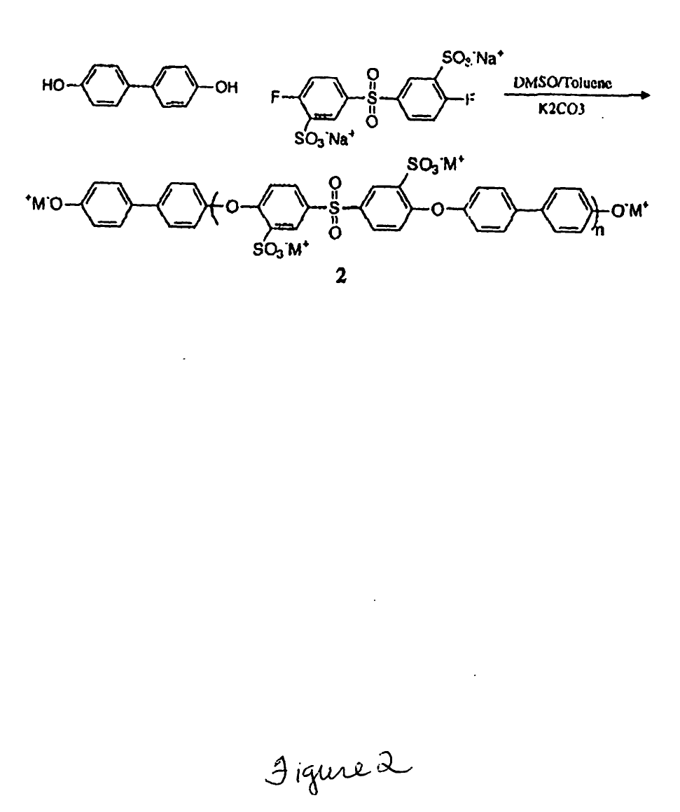

Biphenol based poly(arylene ether sulfone) (2): The desired hydroxyl-terminated sulfonated poly(arylene ether sulfone) (BPS) was synthesized from 3,3′-disulfonated-4,4′-difluorodiphenylsulfone (SDFDPS) and biphenol as illustrated in FIG. 2. Low molecular weight BPS polymers were targeted using an excess biphenol as the end-capping group. Into a 100 mL three-necked flask equipped with a mechanical stirrer, nitrogen inlet and a Dean-Stark trap was added biphenol (0.3724 g, 2.0 mmol) and 4,4′-difluorodiphenylsulfone (0.7688 g, 1.66 mmol). Potassium carbonate (0.828 g, 6 mmol) was added and sufficient DMSO (7 mL) was introduced to make a 14% (w/v) solid concentration. Toluene (5 mL) was used as an azeotroping agent. The reaction mixture was heated under reflux at 150° C. for four hours to dehydrate the system. The temperature was then slowly raised to 160° C. to distill off the toluene. The reaction mixture was allowed to proceed at this temperature for another. The reaction mixture was cooled to 90° C. before addition of fluorine terminated oligomer 1.

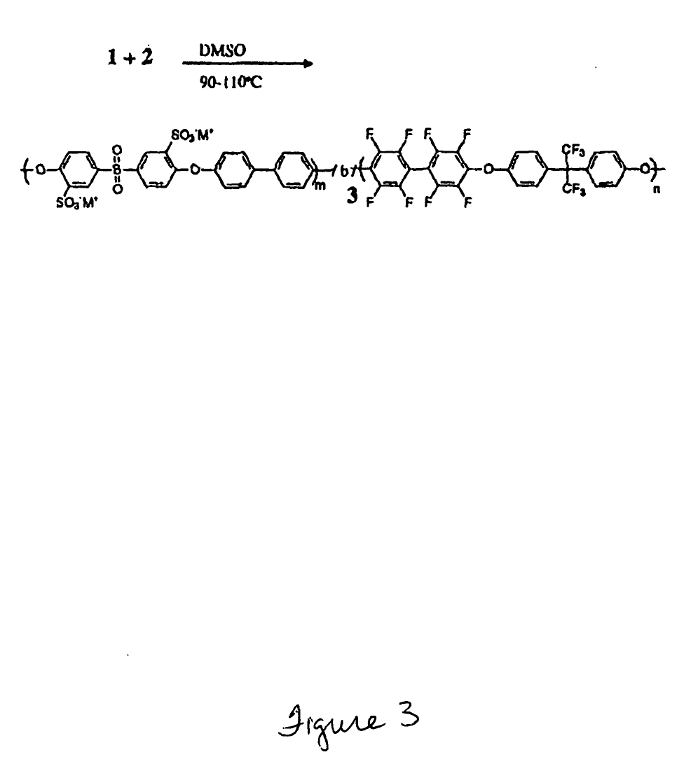

Multiblock copolymer synthesis (3): The mutiblock copolymer was synthesized from the fluorine-terminated polymer 1 and the hydroxyl-terminated macromonomer 2 as ilustrated in FIG. 3. To a preformed solution of polymer 2 was added a solution of macromonomer 1 (1.90 g, 0.3 55 mmol) in DMSO (10 mL) followed by 5 mL of benzene. The addition of macromonomer 1 solution was done in several portions during one hour. The reaction mixture was stirred at 90° C. for 2 h and at 110° C. for 8 h. The viscosity of the mixture increased dramatically during the course of the reaction to the point that more DMSO (40 mL) needs to be added to improve efficiency of stirring. The reaction product was precipitated into 600 mL of water/methanol (1:1 in volume fraction). The precipitated polymer was filtered and first treated in boiling deionized water for 24 h and then treated in boiling THF for 4 h before being dried at 80° C. for 48 h in a conventional oven. The reaction yield was 75-80%.

Results and Discussion

As depicted in FIG. 3, a series of multiblock copolymers were prepared by the reaction of the dialkali metal salt of bisphenol-terminated disulfonated poly(arylene ether sulfone)s with decafluorobiphenyl-terminated poly(arylene ether)s in a polar aprotic solvent. The reaction was rapid and yielded copolymers with light yellow color. The dialkali metal salts of bisphenol-terminated disulfonated poly(arylene ether sulfone) were generated using 3,3′-disulfonated-4,4′-difluorodiphenylsulfone and excess amount of biphenol in the presence of potassium carbonate at 160° C. (FIG. 2). By controlling the amount of biphenol monomer two samples with target molecular weight of 5K and 15K was prepared. The sulfonated copolymers were used in next step without isolation. Similarly, decafluorobiphenyl-terminated poly(arylene ether)s were synthesized using 6F—BPA and excess amount of decafluorobiphenyl in DMAc-benzene mixed solvent (FIG. 1). It is known that perfluoroaromatic monomers are highly reactive toward the nucleophilic aromatic substitution reaction and high molecular weight polymers form at relatively low temperature and short period of time.¹¹⁻¹³ Four fluorinated samples were synthesized with molecular weights ranging from 2.8K to 60K. Low molecular weight samples formed white powder-like product after isolation, whereas the high molecular weight sample formed white fibrous material. The molecular structure of polymer (oligomer) 1 was confirmed by ¹⁹F NMR in CDCl3, and compared with 6F—BPA and decafluorobiphenyl. FIG. 4 shows the aromatic region of ¹⁹F NMR spectrum for polymer 1 with target molecular weight of 5K. This spectrum shows two major peaks at −137.5 and −152.4 ppm, which were assigned to the aromatic fluorine atoms of decafluorobiphenyl units. The enlarged spectrum of the aromatic region reveals three small peaks at −137.2, −149.8 and −160.2 ppm. Comparison of these peaks with those in the ¹⁹F NMR spectrum of dceafluorobiphenyl suggests that these small peaks can be assigned to the pentafluorophenyl end group of the polymer. Relative integral intensity of the small peaks to the major peaks was used to estimate degree of polymerization.

Reaction of the fluorinated oligomer 1 with preformed sulfonated 2 proceeded rapidly evidenced by sharp increase in viscosity of reaction solution mixture in the first 1-2 hours. Dilution of reaction mixture with DMSO had little effect on lowering the viscosity of the solution. Products after isolation were treated in boiling water and boiling THF separately, in order to purify the product from unreacted starting oligomers. After testing the samples it was found that about 20-25% of the products are soluble in THF. Further investigation revealed the nature of THF soluble part to be oligomer 1.

Multiblock copolymers 3 formed flexible films cast from solution. These films were tested for ion exchange capacity by titrating with sodium hydroxide standard solution (Table 1). The multiblock copolymers had high water uptake both in salt and acid form. Conductivity of these materials in their fully hydrated form in liquid water showed values between 0.12-0.32 S/cm (Table 1). As expected, the behavior is quite different than for random copolymers.

TABLE 1

| | Block size | | IEC | | | |
|---|---|---|---|---|---|---|
| | (Kg/mol)¹ | | (meq/g)² | | | Conductivity |
| Sample | S | F | Calc. | Exp. | Water Uptake (%) | (S · cm−1)³ |
| 3a | 5 | 2.8 | 2.05 | 2.29 | 470 | 0.32 |
| 3b | 15 | 15 | 1.30 | 1.46 | 260 | 0.16 |
| 3c | 5 | 5 | 1.6 | 1.5 | 130 | 0.12 |
| MB-210 | 5 | 2.8 | 2.05 | 2.10 | 360 | — |
| MB-117 | 5 | 5 | 1.55 | 1.17 | 115 | — |
| MB-095 | 3.2 | 5.3 | 1.17 | 0.95 | 41 | — |
| Nf-1135 | — | — | — | — | 0.89 | 38 |

¹“S” represents the sulfonated block and “F” represents the fluorinated block.
²Samples were acidified in 0.5 M boiling sulfuric acid for 2 hours and boiling deionized water for 2 hours.
³measured at room temperature in liquid water.

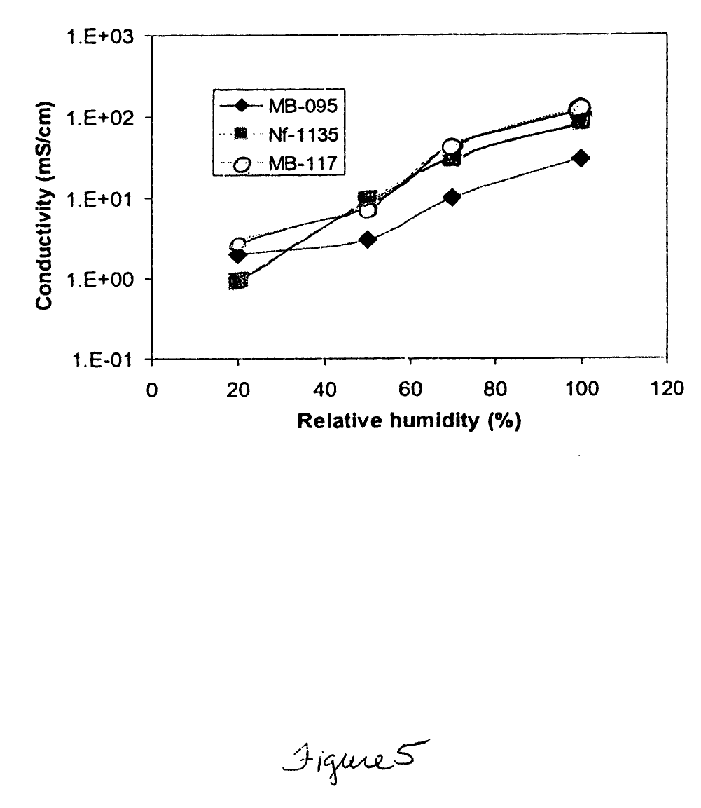

FIG. 5 displays the effect of relative humidity on proton conductivity for two multiblock polymers (MBs) and Nafion 1135. As expected, the proton conductivity for both MBs and Nafion decreased exponentially as the relative humidity decreased. Both MBs exhibit higher proton conductivities than Nafion at low relative humidity. This may be attributed to the existence of nano-structure morphology forming sulfonated hydrophilic domains surrounded by fluorinated hydrophobic segments.

This example demonstrates that novel multiblock copolymers derived from hydroxyl terminated poly(arylene ether sulfone) macromonomers and aromatic fluorinated telechelic macromonomers were made and are applicable for proton exchange membranes. The proton exchange membrane comprises of a hydrophilic region containing pendant proton conducting sites, which is covalently bonded to a hydrophobic region

While we have shown and described specific embodiments of the present invention, further modifications and improvements will occur to those skilled in the art (e.g., the addition of different functional groups/moieties). We desire it to be understood, therefore, that this invention is not limited to the particular forms shown.

### REFERENCES

(1) Kobsyashi, T.; Rikukawa, M.; Sanui, K,; Ogata, N. Solid State Ionics 1998, 106, 219-225.
(2) Bae, J. M.; Honma, I.; Murata, M.; Yamamoto, T.; Rikukawa, M.; Ogata, N. Solid State Ionics 2002.
(3) Kerres, J.; Ullrich, A.; Meier, F.; Haring, T. Solid State Ionics 1999, 125, 243-249
(4) Wang, F.; Hickner, M.; Kim, Y. S.; Zawudzinski, T. A.; McGrath, J. E. J. Membrane Science 2002, 197, 231-242.
(5) Cooper, J. E. J. Polym. Sci. Part A; Polym. Chem. 1971, 9, 2361.
(6) (a) Hruszka, P.; Jurga, J.; Brycki, B. Polymer 1992, 33, 248; (b) Miyatake, K.; Shouji, E.; Yamamoto, K.; Tsuchida, E. Macromolecules 1997, 30, 2941.
(7)Iqbal, M.; Wightman, J. P.; Lloyd, D. R.; McGrath, J. E., J Polym Sci Polym Chem Ed 1984,22, 721.
(8) Ghassemi, H.; McGrath, 3. B. J. Polym. Sci. Part A; Polym. Chem. 2003, in press
(9) Harrison, W. L; Wang, F.; Mecham, 3. B.; Bhanu, V. A.; Hill, M.; Kim, Y. S.; McGrath, J. E. J. Polym. Sci. Part A; Polym. Chem. 2003,41, 2264-2276.
(10) Ghassemi, H.; Grace, N.; McGrath. J. E. J. Polym. Sci. Part A; Polym. Chem 2003, in press.
(11) Liu, F.; Ding, J.; Li, M.; Day, M.; Robertson, G.; Zhou, M.; Macromol, Rapid Commun. 2002, 23, 844-848.
(12) Kim, J. P.; Kang, J. W.; Kim, J. J.; Lee, J. S.; Polymer, 2003,44, 4189-4195.
(13) Kameneva, T. M.; Malichenko, B. F.; Shelud'ko, E. V.; Pogorelyi, V. K.; Sherstyuk, A. I.; Rozhenko, A. B. Zhurnal Organicheskoi Khimii 1989, 25(3), 576-82.

While the invention has been described in terms of its preferred embodiments, those skilled in the art will recognize that the invention can be practiced with modification within the spirit and scope of the appended claims. Accordingly, the present invention should not be limited to the embodiments as described above, but should further include all modifications and equivalents thereof within the spirit and scope of the description provided herein.

We claim:

1. A multiblock copolymer with chemical structure 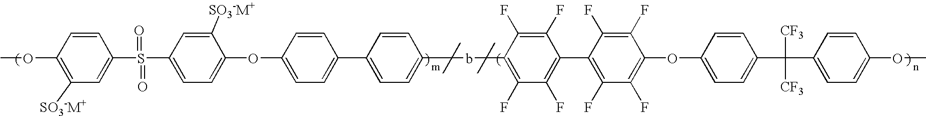
where M+ is a positively charged counterion selected from the group consisting of potassium, sodium and alkyl amine, m=2 to 50, n=2 to 30, and b represents connection of respective blocks.

2. The multiblock copolymer of claim 1, wherein m+n is at least 4.

3. The multiblock copolymer of claim 1, wherein m+n is from 4 to 80.

4. A proton exchange membrane (PEM) comprising a multiblock copolymer that comprises at least one hydrophobic segment and at least one hydrophilic segment,
wherein the membrane has co-continuous morphology of hydrophobic and hydrophilic segments, has a mean humidity in a range of from 10% to 80%, and has proton conductivity in a range of from 0.005 to 0.3 S/cm.

5. The PEM of claim 4, wherein the mean humidity is in a range of 25% to 70%.

6. The PEM of claim 4, wherein the proton conductivity is in a range of 0.05 to 0.25 S/cm.

7. The PEM of claim 4, wherein the mean humidity is in a range of 25% to 70% and the proton conductivity is in a range of 0.05 to 0.25 S/cm.

8. The PEM of claim 4, wherein the hydrophobic segment is perfluorinated.

9. The PEM of claim 4, wherein the hydrophilic segment is disulfonated.

10. A method of making a multiblock copolymer comprising a fluorinated hydrophobic segment and a sulfonated hydrophilic segment, comprising the step of:
reacting at least one fluorinated block with at least one sulfonated block in a condensation reaction to form a multiblock copolymer.

11. The method of claim 10, wherein the fluorinated block itself was made by a condensation reaction.

12. The method of claim 10, wherein the sulfonated block itself was made by a condensation reaction.

13. The method of claim 10, wherein the fluorinated block and the sulfonated block themselves were made by condensation reactions.

14. The method of claim 10, wherein at least two fluorinated blocks and at least two sulfonated blocks are reacted in the condensation reaction.

15. The method of claim 10, wherein a number of fluorinated blocks being reacted in the condensation reaction is in a range of 2 to 30 and a number of sulfonated blocks being reacted in the condensation reaction is in a range of 2 to 50.

16. The method of claim 10, wherein a sufficient number of blocks are used in the condensation reaction to form a polymer electrolyte membrane.

17. The method of claim 10, wherein the fluorinated block is a perfluorinated block.

18. The method of claim 10, wherein the sulfonated block is disulfonated.

19. The method of claim 13, wherein the multiblock copolymer of claim 1 is formed by the condensation reaction.

20. The method of claim 10, wherein a multiblock copolymer comprising at least two perfluorinated poly(arylene ether) segments and at least two disulfonated poly(arylene ether sulfone) segments is formed.

21. The method of claim 10, wherein by a step growth procedure, a proton exchange membrane is constructed.

22. An ion-exchange resin comprising a multiblock copolymer comprising at least one fluorinated hydrophobic segment and at least one sulfonated hydrophilic segment, wherein the multiblock copolymer has been formed by a condensation reaction.

23. The ion-exchange resin of claim 22, wherein the sulfonated hydrophilic segment is disulfonated.

24. The ion-exchange resin of claim 22, wherein the fluorinated hydrophobic segment is a perfluorinated ether.

25. The ion-exchange resin of claim 22 including perfluorinated poly(arylene ether) and disulfonated poly(arylene ether sulfone) segments.

26. A fuel cell comprising:
a polymer electrolyte membrane (PEM) comprising a multiblock copolymer comprising: at least one fluorinated hydrophobic segment and at least one sulfonated hydrophilic segment, wherein the multiblock copolymer has been formed by a condensation reaction;
an anode and a cathode.

27. The fuel cell of claim 26, wherein the sulfonated hydrophilic segment is disulfonated.

28. The fuel cell of claim 26, wherein the fluorinated hydrophobic segment is a perfluorinated ether.

29. The fuel cell of claim 26, wherein the PEM includes perfluorinated poly(arylene ether) and disulfonated poly(arylene ether sulfone) segments.
